(19) United States
(12) Patent Application Publication
(10) Pub. No.: US 2005/0016985 A1
(43) Pub. Date: Jan. 27, 2005

(54) Electrically-operated temperature-regulated scented wax warmer

(76) Inventors: Rodney Haas, SamutPrakarn (TH); Frederick V. Gabriel, Eastham, MA (US)

Correspondence Address: CHARLES G. CALL, 68 HORSE POND ROAD, WEST YARMOUTH, MA, 02673-2516, US

(21) Appl. No.: 10/837,049

(22) Filed: May 1, 2004

Related U.S. Application Data
(60) Provisional application No. 60/466,967, filed on May 1, 2003.

(51) Int. Cl. F27D 11/00

(52) U.S. Cl. 219/438; 392/403; 392/390

(57) ABSTRACT

An electrically operated scented wax holder that forms a receptacle for receiving unmelted blocks of wax which are heated to the melting point and thereafter maintained at a safe temperature by a temperature-regulated electrical heating element. The wax receptacle is removable mounted on a base section that houses a positive temperature coefficient (PTC) thermistor which has a transition temperature substantially higher than the melting point of the wax to insure that the wax is rapidly melted, but substantially below the temperature that would constitute a danger to a human who might touch the exterior surface of the warmer, or constitute a fire hazard. The heating element is preferably placed in thermal contact with a contact pad having high thermal conductivity that is in turn placed closely adjacent to the wax receptacle, thereby efficiently transferring heat from the electrically operated temperature regulated heating element to the wax in the receptacle. A switch is positioned to de-energize the heating element whenever the wax receptacle is removed from the base section, and a visible pilot light is illuminated whenever the heating element is energized.

### CROSS REFERENCE TO RELATED APPLICATIONS

This application is a Non-Provisional of, and claims the benefit of the filing date of, U.S. Provisional Patent Application Ser. No. 60/466,967 filed on May 1, 2003, the disclosure of which is incorporated herein by reference.

### FIELD OF THE INVENTION

This invention relates electrically heated warmers for use with scented wax or aromatic oils.

### BACKGROUND OF THE INVENTION

Scented wax is commonly heated in decorative holders which form a retaining receptacle positioned at the top of a vented enclosure. A small candle is positioned within the enclosure below the receptacle. A small block of scented wax, commonly called a “scent block” or “tart,” is placed in the cavity. The heat from the burning candle melts the scented wax in the cavity to release the scent into the surrounding area.

Tart warmers heated by candles have several notable disadvantages. Different candles produce widely varying amounts of heat. If the candle burns poorly, the wax may be slow to melt or may not melt at all, or may not reach the temperature needed to produce the desired scent. If the candle burns too well, too much heat may be produced, creating a safety hazard. As a result, users of candle-heated tart warmers are cautioned never to leave a burning candle in the warmer unattended. In addition, the heating candles must be frequently replaced and the candle holding enclosure needs to be periodically cleaned to remove residual wax.

To eliminate some of the problems found in candle-heated scent warmers, electrically heated, lantern-like tart warmers have become popular. In these units, the candle is replaced by an incandescent electrical light bulb that heats a scented wax tart placed in a receptacle formed at the top of the lantern. In order to provide adequate heat to melt the scented wax, these lantern units must be large enough to contain a large conventional light bulb and are hence quite bulky. Moreover, the light bulb must be periodically replaced with a new bulb having the proper power rating. Using an available replacement bulb having a power rating that is too low fails to adequately heat the scented wax, and using a bulb with a power rating that is too high overheats the wax and creates a potential fire hazard.

It is therefore an object of the present invention to provide an improved electrically-operated scented wax warmer that can be much smaller, requires less maintenance, and provides a precisely regulated temperature for heating the scented wax for enhanced safety and performance.

### SUMMARY OF THE INVENTION

The present invention takes the form of a scented wax holder that forms a receptacle for receiving unmelted scented wax and a temperature-regulated electrical heating element in thermal contact with the receptacle for melting the wax and thereafter maintaining the wax at a regulated temperature.

In its preferred form, the present invention comprises a wax receptacle is removable mounted on a base section that incorporates a temperature-regulated electrical heating element. The heating element preferably consists of a positive temperature coefficient (PTC) thermistor which has a transition temperature substantially higher than the melting point of the wax to insure that the wax is rapidly melted, but substantially below the temperature that would constitute a danger to a human who might touch the exterior surface of the warmer, or constitute a fire hazard. The heating element is preferably placed in thermal contact with a contact pad having high thermal conductivity that is in turn placed closely adjacent to the wax receptacle, thereby efficiently transferring heat from the electrically operated temperature regulated heating element to the wax in the receptacle.

Both the wax receptacle and the base section which houses the electrical heating element are preferably formed from a material such as slip cast stoneware that exhibits a low thermal conductivity such that the heat from heating element and the heated wax does not flow to the those portions of the warmer which are most likely to be come in contact with a person using the warmer or with surrounding objects.

### BRIEF DESCRIPTION OF THE DRAWINGS

In the detailed description which follows, frequent reference will be made to the attached drawings, in which:

FIG. 1 is a perspective view of the wax holder;

FIG. 2 is a perspective view of the contact pad with the heating element positioned as shown by the phantom lines;

FIG. 3 is a perspective view of the base section that houses the heating element and contact pad;

FIG. 4 is a cross-sectional view of the wax vessel, base section and heating element;

FIG. 5 is an exploded view of the components which form the base section heating element;

FIG. 6 is an exploded view of a further embodiment of the invention which includes a holder for a candle and a translucent covering dome; and

FIG. 7 is a cross-sectional view of a further embodiment of the invention incorporating a switch for disconnecting the heating element when the wax receptacle is removed and a pilot light for indicating when the heating element is energized.

### DETAILED DESCRIPTION

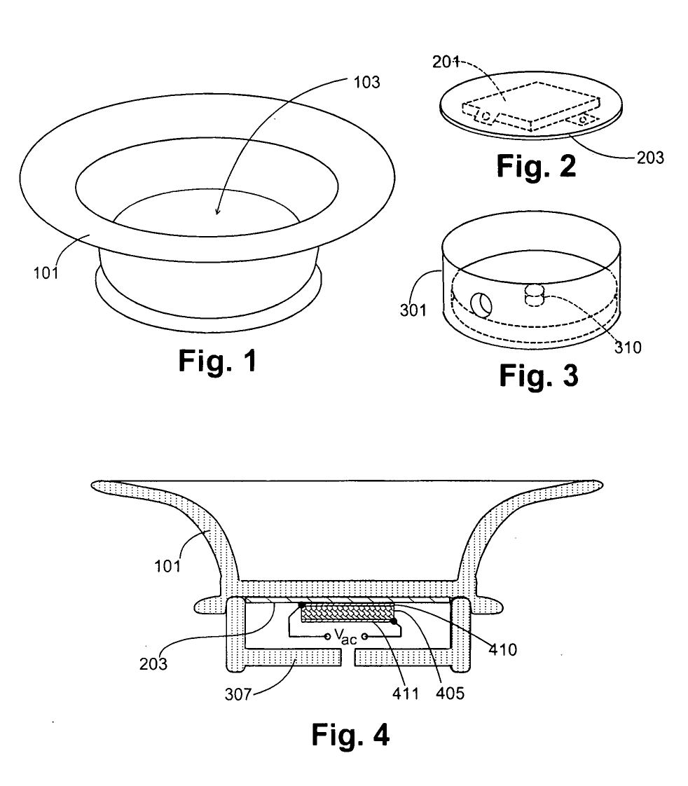

A preferred embodiment of the invention consists of a wax vessel shown in FIG. 1 and a base section shown in FIGS. 2 and 3. The wax vessel 101 forms a receptacle for receiving a block of scented wax which is dropped into the wax holding receptacle indicated at 103. The wax vessel 101 and the base section are both preferably slip cast stoneware fired ceramic pieces which are coated with a kiln-fired decorative glaze to enhance their appearance and facilitate cleaning. The wax vessel is preferably a separate unit which can be removed from the base section shown in FIGS. 2 and 3 for ease of cleaning; however, the base section and wax vessel may be a single structure if desired. Both the base section and the wax vessel may take a variety of decorative shapes and, as will be understood from the following description, may be substantially smaller than conventional tart warmers.

In accordance with the invention, a temperature regulated heating element seen at 201 in FIG. 2 is attached to the underside of a contact pad 203 and both are housed within a cylindrical base section 301 seen in FIG. 3.

As shown in cross-section in FIG. 4, the contact pad 203 is placed in direct contact with the floor 403 of the wax vessel to provide a large surface area for better heat transfer between the heating element seen generally at 201 and the wax vessel. The heating element consists of a thermistor material 405 sandwiched between two conductive metal contact plates 410 and 411. A source of an electrical potential, preferably standard household 120 volt A.C., is connected across the contact plates 410 and 411 to supply a heating current to the resistive heating material 405.

The resistive heating material 405 preferably comprises a positive temperature coefficient (PTC) thermistor. PTC thermistors have the ability to function as self-regulating heating elements. They can operate at a nearly constant temperature over a broad range of voltage and heat dissipation conditions and can be manufactured in many different configurations including discs and rectangles. Multiple PTCs can be used in parallel to provide constant heating over a larger area. Switching PTC thermistors have a resistance-temperature characteristic that exhibits a very small negative temperature coefficient until the device reaches a critical temperature that is referred to as its “Curie”, switch or transition temperature. As this critical temperature is approached, the devices begin to exhibit a rising, positive temperature coefficient of resistance as well as a large increase in resistance. The resistance change can be as much as several orders of magnitude within a temperature span of a few degrees. Most PTC thermistors are designed to operate with a transition temperature somewhere between 60° C. and 120° C., however, devices can be manufactured that can switch as low as 0° C. or as high as 200° C.

These desirable heating characteristics are provided at low cost without the need for a separate thermostat. The PTC elements have virtually unlimited live, cause no electrical noise, have no moving parts to wear out, and are very efficient. PTC heating characteristics have been used to advantage in curling irons, hot melt glue guns, diesel fuel heaters, plug-in “night-light” liquid aroma heaters, and other self-regulating heating applications. PTC heating elements are available from Advanced Thermal Products, Inc., St. Marys, Pa. 15857.

PTC thermistors are particularly advantageous for use as scented wax heaters because they are able to rapidly melt and thereafter maintain the liquefied wax at a predetermined constant temperature above the melting point of the wax to most effectively release the fragrance from the wax. When used in a ceramic heater of the type described in FIGS. 1-5, the PTC thermistor should have a transition temperature within the range from 230 to 250 degrees Fahrenheit to maintain the melted wax at a temperature of approximately 180 degrees Fahrenheit.

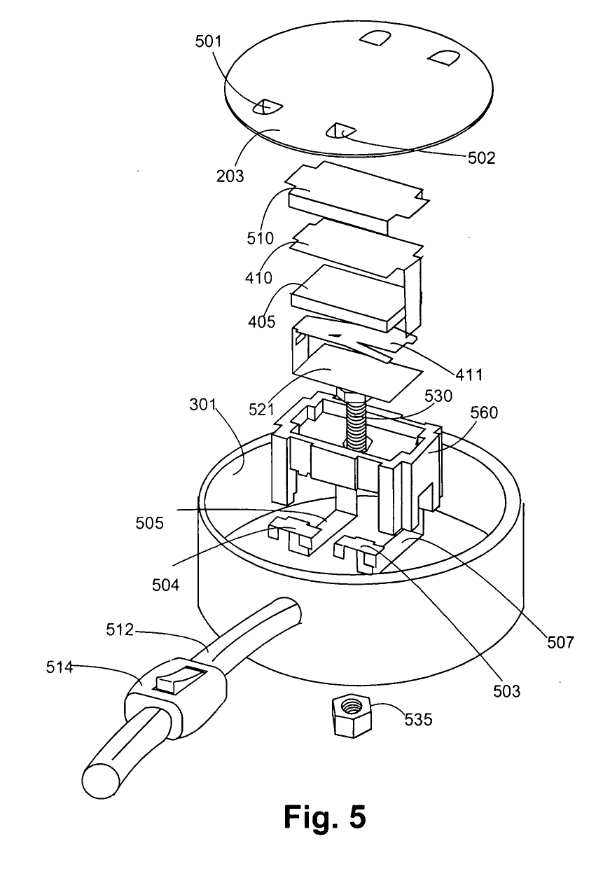

The components used to fabricate heating element for a scented wax heater are shown in the exploded perspective view of FIG. 5.

The contact pad 203 is formed from a 0.3 mm aluminum punched plate. Four tabs are punched through the pad 203, two of which seen at 501 and 502 fold against and retain the mounting tabs 503 and 504 respectively. The tabs 503 and 504 are formed on the 0.3 mm punched steel clamps 505 and 507 respectively. In this way, the clamps 505 and 507 secure the ceramic housing 560 and the other heating element components to the contact pad 203.

The PTC thermistor element 405 is clamped between two punched 0.2 beryllium copper contacts 410 and 411 which transfer electrical current to the element using connections (not shown) to the conductors of an electrical power cord 512 which includes a conventional cord switch 514 used to turn the heater ON and OFF. A 0.1 mm insulator pad seen at 510 made from either laminated mica paper or Apical Polyamide film provides an electrical insulating barrier between the contact pad 203 and the upper electrical contact 410 but provides thermal transmission from the PTC element 405 to the contact pad 203.

The lower dielectric Insulator pad 521 is constructed of 0.1 mm laminated mica paper or apical polyamide film providing an electrical insulation barrier between the lower contact and the mounting screw 530. The PTC heating element 405 and the contacts 410 and 411 nest within a molded ceramic housing 560 that provides a structure for holding the PTC element and contact assembly to the decorative ceramic base 301. The assembly clamps 505 and 507 secure the ceramic heater element housing 560 and PTC assembly to the contact pad 203.

The head of the mounting screw 530 nests within a hexagonal recess in the top of the ceramic housing 560 and the threaded end of the screw 530 extends downwardly through the central bore 310 in the ceramic base 301 seen in FIG. 3. A threaded nut 535 and a lock washer (not shown) secure the screw 530 and the heating element assembly to the ceramic base 310.

The slip cast stoneware fired ceramic base element 301 provides an electrically insulated barrier between the element electrical connections and the user, aligns the upper aroma vessel 101 in thermal contact with the contact pad 203 of the heating element, and provides a support for the power cord 512.

When the switch 514 is turned ON, the PTC heating element provides rapid warm-up of the scented wax to a precisely controlled temperature which is above the melting point of the scent block but below fire hazard temperature. The resulting wax melting and warming unit accordingly provides safe, healthy, low-cost, energy efficient and reliable operation.

An electrical switch may be added to automatically turn off the heating element when the scent holder is removed from the heating unit. The heating assembly, including the contact plate, may be supported for vertical movement against pressure supplied by a resilient element, such as a Belleville washer, and a contact switch positioned to turn on when the assembly is pressed downward by the weight of the scent holder, and to turn off, removing power from the heating element, when the scent holder is lifted off the heating unit. The pilot light (not shown in FIG. 5) may be integrated into the housing of the switch 514 or may be positioned on the outside of, or be visible through an opening through, the housing 301 of the base unit to indicate when the unit is being powered, thereby reminding the user to turn to unit off when it is not in use.

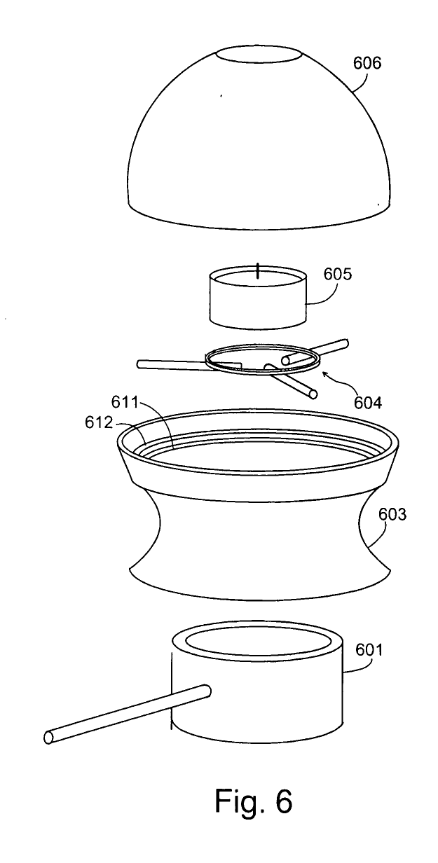

A further embodiment of the invention shown in FIG. 6 comprises a regulated electric heater 601, a scent holder 603 which is supported by the heater 601, a tea-light candleholder 604 which nests in and is supported by the scent holder 603, a tea-light candle 605 which is supported by the candle holder 604, and a translucent dome 606 which is also supported by the wax holder 603. The heater 601 is preferably constructed as shown in FIG. 5. The scent holder 601 is supported by the heater 601 and forms a bowl of adequate size to accept and hold one or more blocks of unmelted scented wax in the location illustrated at 103 in FIG. 1. Aromatic oils may also be placed in the bowl. The upper rim of the scent holder 603 defines two annular interior rims 611 and 612 which engage with and support the candle holder 603 and the dome cover 606 respectively. The dome cover is translucent and is illuminated by the candle 605, and defines a circular opening at the top through which the heat from the candle and the aroma liberated by the heated scent in the scent holder 603 is expelled and which further permits fresh air to enter and to circulate as the candle burns, enhancing the amount of aroma liberated by the heated scent. The dome, candle, and candle holder may be easily removed for cleaning. Moreover, as in the case of the arrangement shown in embodiment of FIGS. 1-4, the scent holder may be separated from the heating element 601 for cleaning, which is often most easily accomplished by placing the scent holder in the freezer compartment of a refrigerator to solidify any remaining in the holder, which may then be easily separated from the holder. In addition, multiple pie-shaped reservoirs may be formed in the interior bottom surface of the scent holder to receive and keep separate several different scents, permitting the user to combine aromas as desired.

The candle shown in FIG. 6 may be replaced with an electric lamp, such as a candle simulating flickering lamp bulb which mates with and receives power from a socket in a lamp holder positioned and supported in the same way as the candle holder 604. Electrical conductors embedded in the scent holder 603 and passing from the lamp holder to a mating female connector in the heater can be used to provide power to the electric lamp using the same power cord that supplies household voltage to the heating element.

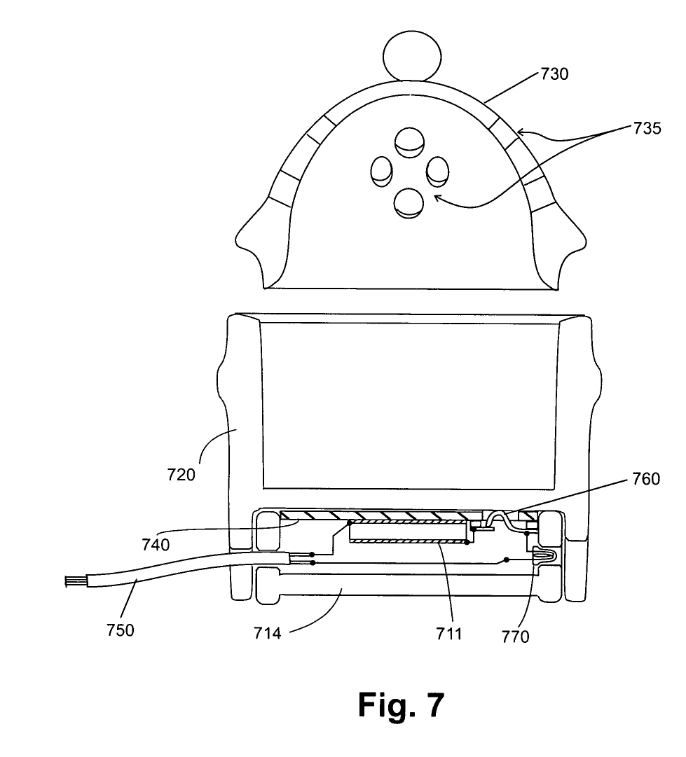

Still another embodiment is shown in FIG. 7. The regulated electric heater 711 is mounted in a ceramic base unit 714. The receptacle 720 sits on top of the base unit 714 and holds a scented wax or other aromatic material that liberates a scent when heated. A dome cover 730 sits on top of and is supported by the receptacle 720 and includes numerous vent openings as seen at 735 which allow the scent to escape. The base unit 714, the receptacle 720 and the dome cover 730 may all be formed as slip cast stoneware fired ceramic pieces. The dome cover 730 and the receptacle 720 may be decorated with glaze patterns. The dome cover 730 and the scent receptacle 720 may be removed for cleaning.

As seen in FIG. 7, the regulated electric heater, which preferably takes the form of a PTC thermistor, is attached to the underside of a metal support plate 740. The base unit 714 is similar in construction to the base unit shown in detail in FIG. 5 with the following differences:

First, the support plate 740 may be rigidly affixed to the ceramic base housing 714 and includes an opening through which a flexible switch leaf-spring blade of the switch 760 projects. The switch 760 is held in a closed position when the scent receptacle 720 is placed on the base unit, but the flexible blade of switch 760 deflects upwardly to an open position when the receptacle 720 is removed from the base. In this way, whenever the base unit is removed when power is applied through the cord switch (not shown in FIG. 7 but seen at 514 in FIG. 5), the heating element is automatically de-energized.

Second, a pilot 770 is interconnected with the heating element 711, the switch 760, and the conductors of the power cord 750 and is illuminated whenever the heating element is energized. The sidewalls of the scent receptacle 720 extend downwardly forming a skirt around the periphery of the base unit 714. Upwardly extending U-shaped notches are formed on opposing sides of this skirt. The first of these notches provides a passageway through which the electrical power cord 750 passes, and the other notch provides a window through which the user can view the pilot light 770. The configuration shown in FIG. 7 accordingly permits the base heating element to be used with receptacles and/or receptacle covers on any desired color or decorative style since the receptacle effectively surrounds the entire base unit with the exception of the passageways through which the power cord passes and through which the pilot light is viewed.

Conclusion

It is to be understood that the embodiments of the invention which has been described is merely an illustrative application of the invention, and numerous modifications may be made to the structures shown without departing from the true spirit and scope of the invention.

1. An electrically operated scent warmer comprising a receptacle for receiving one or more blocks of wax that produces a scent when melted and a temperature-regulated electrical heating element in thermal contact said the receptacle for heating said wax and thereafter maintaining said wax at a regulated temperature.

2. An electrically operated scent warmer as set forth in claim 1 wherein said temperature-regulated heating element is a thermistor.

3. An electrically operated scent warmer as set forth in claim 2 wherein said temperature-regulated heating element is a thermistor exhibiting a positive temperature coefficient that operates at a nearly constant temperature over a range of heat dissipation conditions.

4. An electrically operated scent warmer as set forth in claim 3 wherein said heating element is mounted in a base unit which is detachable from said receptacle.

5. An electrically operated scent warmer as set forth in claim 4 further including a pilot light that is illuminated whenever said heating element is energized.

6. An electrically operated scent warmer as set forth in claim 4 further including a switch for de-energizing said heating element whenever said receptacle is detached from said base unit.

7. An electrically operated scent warmer as set forth in claim 1 wherein said heating element is mounted in a base unit which is detachable from said receptacle.

8. An electrically operated scent warmer as set forth in claim 7 further including an electrical power supply conductor for connecting said temperature-regulated electrical heating element to an available electrical power source and a manually operable electrical switch serially connected with said conductor for energizing and de-energizing said heating element.

9. An electrically operated scent warmer as set forth in claim 8 further including a pilot light that is illuminated whenever said heating element is energized.

10. An electrically operated scent warmer as set forth in claim 7 further including a switch for de-energizing said heating element whenever said receptacle is detached from said base unit.

11. An electrically operated scent warmer as set forth in claim 1 further including an electrical power supply conductor for connecting said temperature-regulated electrical heating element to an available electrical power source and a manually operable electrical switch serially connected with said conductor for controlling energizing and de-energizing said heating element.

12. An electrically operated scent warmer as set forth in claim 11 further including a visible pilot light connected to said switch for indicating when said heating element is energized.

13. An electrically heated scent warmer comprising, in combination, a receptacle for holding wax that liberates a scent when warmed to its melting temperature, and
an electrically operated temperature regulated heating element for heating said receptacle.

14. An electrically heated scent warmer as set forth in claim 13 wherein said receptacle is removably mounted on a base unit that houses said heating element.

15. An electrically heated scent warmer as set forth in claim 14 further including a pilot light that is illuminated whenever said heating element is energized.

16. An electrically operated scented wax warmer comprising, in combination,
base unit including an electrically operated heating element, a power cord for connecting said heating element to a source of electrical power, and means for regulating the temperature of said heating element at a substantially constant temperature when said heating element is connected to said source, and
a wax receptacle removably mounted on said base unit for receiving one or more blocks of scented wax, said wax receptacle being in thermal contact with said heating element when mounted on said base unit.

17. An electrically operated scented wax warmer as set forth in claim 16 wherein said heating element includes a metal contact pad having high thermal conductivity that is positioned closely adjacent to and in thermal contact with said wax receptacle to efficiently transfer heat from the electrically operated heating element to the wax in the receptacle.

18. An electrically operated scented wax warmer as set forth in claim 17 wherein said receptacle is adapted to receive and support a translucent cover and wherein said receptacle and cover house a source of illumination.

19. An electrically operated scented wax warmer as set forth in claim 18 wherein said source of illumination is a candle.

20. An electrically operated scented wax warmer as set forth in claim 18 wherein said source of illumination is an electric lamp.
